(19) United States
(12) Patent Application Publication
(10) Pub. No.: US 2006/0267750 A1
(43) Pub. Date: Nov. 30, 2006

(54) Tire abnormal state monitoring system for an automotive vehicle

(75) Inventors: Jianbo Lu, Livonia, MI (US); Joseph Meyers, Farmington Hills, MI (US)

Correspondence Address: ARTZ & ARTZ, P.C., 28333 TELEGRAPH ROAD, SUITE 250, SOUTHFIELD, MI, 48034, US

(73) Assignee: Ford Global Technologies, LLC

(21) Appl. No.: 11/138,000

(22) Filed: May 26, 2005

(51) Int. Cl. B60Q 1/00

(52) U.S. Cl. 340/440; 280/5.502

(57) ABSTRACT

A control system for controlling an automotive vehicle (10) is set forth. Various tire parameters such as a rolling radius, a vertical spring rate, and a tire rotational spring rate may be used to determine a tire abnormal state. The vehicle (10) is controlled in response to the tire abnormal state. To control the vehicle various dynamic control systems such as anti-lock brakes, traction control, various sensors existing in the vehicle such as a yaw signal, roll signal and pitch signal may be used to determine a tire parameter.

### TECHNICAL FIELD

The present invention relates generally to a tire monitor for an automotive vehicle and, more specifically, to a system that monitors an abnormal state of a tire of a moving vehicle including but not limited to a significant tire pressure drop, tire imbalance, the presence of a mini tire, severe tire wear and tire tread separation.

### BACKGROUND

Since the tire/road contact patches determine the dynamic behavior of an automobile, tires are an important safety-critical part of an automobile. More specifically, their normality has an impact on the safety, handling and fuel economy of the vehicle, for example:
Low tire pressure may cause unstable vehicle motion.
Tire tread separation may lead to a variety of unstable vehicle motions. For example, a tire separation at rear wheels could induce over-steer which makes the vehicle more unstable. Some of the contributions of the tire separation include low tire pressure and high operating temperature.
Severe tire wear may cause an untrue driving feeling and degrade vehicle handling performance.
Tire imbalance may cause tire grip variation, which in turn may cause a varying stability. It could also impact the braking distance of a vehicle especially during high speed driving.
Mini tire usage may cause an inaccurate computation of the tire slip, which may cause a false activation of brake controls including anti-lock brakes (ABS), traction control (TCS), roll stability control (RSC) and yaw stability control (YSC).
Tread wear variation due to normal wear or if only two tires of a vehicle are replaced may make the vehicle more unstable in snow and wet surface driving.

Among the aforementioned abnormalities of tires, tire pressure drop detection has received attention. Several methods have been set forth to monitor the tire pressure drop of an automotive vehicle without directly using tire pressure sensors. For example, in U.S. Pat. Nos. 4,224,597 and 5,218,862, the ABS wheel speed sensor signals are used to estimate the velocity differences between wheels in order to identify which tire or tires have significant pressure drops. The method described in U.S. Pat. No. 5,604,307 considers preventing a false detection from road condition changes. Another approach using wheel speed sensors estimates the pressure of tires utilizing the relationship between the air pressure and the tire spring constants. The air pressure drop affects the resonance frequencies of tire vibrations. Estimating the tire rotational resonance frequency and the tire rotational spring rate are studied in U.S. Pat. Nos. 5,753,809 and 5,826,207. The success of those two methods depends on the proper road excitations to the rotational mode of the tires, and avoiding data processing during some vehicle operation conditions (for example, in braking and turning).

U.S. Pat. Nos. 4,224,597 and 5,218,862 are valid when the involved vehicles are driven at high speed and at stable driving conditions, i.e., in a straight line without large acceleration, deceleration and braking. Since the driving condition other than the above stable/straight driving condition may generate similar wheel speed differences, differentiating those differences is a challenge. U.S. Pat. Nos. 5,753,809 and 5,826,207 use vibration signals to estimate resonance frequencies, which may not be able to detect any tire pressure drop if the specific vibration mode cannot be excited.

The above-mentioned methods are not able to detect tire pressure drops if the road and the vehicle operating conditions are not favorable enough to excite the involved vibrations. For example, if a tire leaks when driven on a curving road at a high speed, and at the same time the vehicle is braking, the aforementioned algorithms cannot detect the leak until the vehicle reaches the road conditions which allow the system to work.

It would therefore be desirable to provide a system that determines tire pressure drop without a direct pressure sensor and that is capable of being used in a wider variety of conditions and with sufficient accuracy. Because there are sensors other than ABS wheel speed sensors in current vehicles equipped with dynamics control systems, such as yaw stability control, roll stability control, ABS braking and traction control, it is desirable to pursue the potential benefit of using more information than wheel speeds to clearly identify road and driving conditions.

Besides monitoring or detecting the tire pressure drops, it is also desirable to provide a system to detect or monitor other aspects of the tire abnormalities such as, but not limited to, the presence of a mini tire, tire imbalance, tire rolling radius variation due to uneven-distributed vehicle loading, tire wearing, etc. With the addition of sensors in the traditional vehicle dynamics control systems, many difficulties faced by using the traditional approaches to detect those abnormalities can now be overcome. Thus, it is desirable to pursue a system which can achieve the other detections by fully utilizing the information from the extra sensor signals and the calculated vehicle motion state variables.

It is desirable to provide a system which can monitor or detect a variety of tire abnormal states by integrating sensor signals and calculated vehicle motion state variables with various qualitative features of the tire abnormal states.

### SUMMARY OF THE INVENTION

The present invention provides a device for monitoring the tire abnormal states including, but not limited to tire pressures based on all the available information from a vehicle dynamics control system. More specifically, the present invention may be used to monitor an abnormal state of a tire of a moving vehicle including but not limited to a significant tire pressure drop, tire imbalance, the presence of a mini tire, severe tire wear and tire tread separation. The system may generate digital information for warning and control purposes in an integrated sensing system (ISS) and an integrated actuation system (IAS), which involve using multiple sensor signals and multiple actuators to achieve arbitrated and prioritized control functions related to vehicle dynamics and vehicle active safety. The tire abnormal state monitor sends a warning signal to the display to warn the driver and sends digital flags to the vehicle dynamics control system so that necessary adjustments and modifications may be performed. Systems requiring modification may include but are not limited to antilock braking, yaw stability control, roll stability control, traction control, 4WD control, transmission control and engine control.

In one aspect of the invention, a method of controlling a vehicle includes determining at least one of a tire rolling radius, determining a tire vertical spring rate, determining a tire rotational spring rate, tire imbalance and determining a tire abnormal state in response to the at least one of the tire rolling radius, the tire vertical spring rate, the tire rotational spring rate and tire imbalance. The vehicle is controlled in response to the detected tire abnormal state. Various types of vehicle control may be performed including warning the driver of the abnormality and/or controlling a dynamic control system of the vehicle in response to the detected tire abnormal state.

In a further aspect of the invention, a method of controlling a vehicle includes generating a wheel speed signal, determining at least one of a vehicle longitudinal velocity, a vehicle lateral velocity, and a vehicle vertical velocity, determining at least one of a yaw signal, a roll signal, and a pitch signal. A tire abnormal state is determined in response to the wheel speed, the at least one of the vehicle longitudinal velocity, the lateral vehicle velocity, the vehicle vertical velocity, the at least one of the yaw signal, the roll signal, and the pitch signal. The vehicle is controlled in response to the tire abnormal state.

One advantage of such a system is that it may be used to detect the tire pressure drops regardless of the vehicle operation condition (accelerating, decelerating and braking) and the road condition (straight, curving, rough, smooth, banked or graded). The other advantage of such a system is that it may be used to trigger control adjustment in vehicle stability control systems so as to achieve better control performance.

Another advantage of the system is that the system detects specific tire abnormal states including but not limited to mini tires, tire imbalance, tire variation due to uneven-distributed vehicle loading, tire wear, etc., by checking the quantitative features of several independently calculated tire parameters in an integrated sense. In this way, the multiple causes of the same symptom could be isolated. For example, a tire rolling radius reduction might be any of tire pressure drops, mini tire with normal tire pressure, large vehicle loading with normal tire pressure, and/or large vehicle loading with low tire pressure.

Hence, checking tire rolling radius may not identify which causes the reduction of tire rolling radius. In the integrated approach of the present application, several separately calculated tire parameters may be checked such that the specific abnormality can be identified.

### BRIEF DESCRIPTION-OF THE DRAWINGS

FIG. 1 is a diagrammatic view of a vehicle with variable vectors and coordinate frames according to the present invention.

FIG. 2 is a block diagram of a stability system according to the present invention.

FIG. 3 is a front view of an automotive vehicle illustrating various angles according to the present invention.

FIG. 4 is a side view of an automotive vehicle showing a pitch angle.

FIG. 5 is a side view of a wheel/tire assembly having vertical and rotational spring rates illustrated thereon.

FIG. 6 is a side view of a tire/wheel assembly having an imbalanced mass thereon.

FIG. 7 is a frequency plot of various frequencies of the vehicle, including body frequency, wheel hop frequency, imbalance mass vibration frequency, and rotational vibration frequency of a tire.

FIG. 8 is a block diagrammatic view of a controller for detecting an abnormal tire state according to the present invention.

FIG. 9 is a plot of the tire parameter determination of FIG. 8.

FIG. 10 is a block diagrammatic view of a tire abnormal state determination logic by monitoring the tire parameters calculated in FIG. 9 in an integrative sense.

FIG. 11 is a flow chart illustrating a method for determining tire abnormal states according to the present invention.

FIG. 12 is a flow chart of a method for determining whether a mini tire is present.

FIG. 13 is a flow chart of a method for determining tire pressure drop.

FIG. 14 is a plot illustrating a method for determining a tire imbalance.

FIG. 15 is a flow chart illustrating how to determine tire wear or tread separation.

FIG. 16 is a flow chart illustrating how to determine an uneven load, a trunk load, or an even load according to the present invention.

### DETAILED DESCRIPTION

In the following figures, the same reference numerals will be used to identify the same components. The present invention may be used in conjunction with a dynamic control system such as a rollover control system for a vehicle. However, the system may be used as a driver warning device. The present invention will be discussed below in terms of preferred embodiments relating to an automotive vehicle moving in a three-dimensional road terrain. Also, the system may be used with a four-wheel drive or all-wheel drive vehicle. Such a vehicle is generally referred to as a four driven wheel vehicle since each of the wheels is capable of generating longitudinal forces derived from the powertrain.

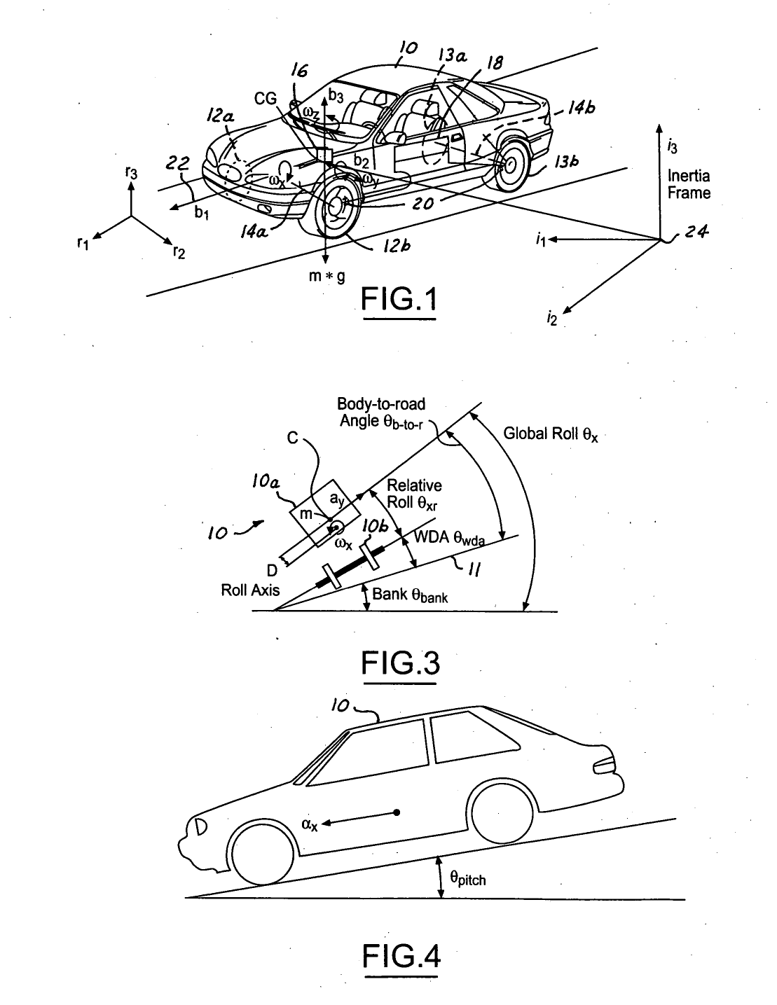

Referring to FIG. 1, an automotive vehicle 10 with a safety system of the present invention is illustrated with the various forces and moments thereon. Vehicle 10 has front right (FR) and front left (FL) wheel/tires 12a and 12b and rear right (RR) wheel/tires 13a and rear left (RL) wheel/tires 13b, respectively. The vehicle 10 may also have a number of different types of front steering systems 14a and rear steering systems 14b, including having each of the front and rear wheels configured with a respective controllable actuator, the front and rear wheels having a conventional type system in which both of the front wheels are controlled together and both of the rear wheels are controlled together, a system having conventional front steering and independently controllable rear steering for each of the wheels, or vice versa. Generally, the vehicle has a weight represented as M*g at the center of gravity of the vehicle, where g=9.8 m/s² and M is the total mass of the vehicle.

As mentioned above, the system may also be used with driver warning systems including active/semi-active suspension systems; active anti-roll bars, airbags or other safety devices deployed or activated upon sensing predetermined dynamic conditions of the vehicle.

The sensing system 16 is coupled to a control system 18. The sensing system 16 may comprise many different sensors including the sensor set typically found in a roll stability control or a rollover control system (including lateral accelerometer, yaw rate sensor, steering angle sensor and wheel speed sensor which are equipped for a traditional yaw stability control system) together with a roll rate sensor and a longitudinal accelerometer. The various sensors will be further described below. The sensors may also be used by the control system in various determinations such as to determine a lifting event, determine a height and position of a mass, a relative attitude, etc. The wheel speed sensors 20 are mounted at each corner of the vehicle and generate signals corresponding to the rotational speed of each wheel. Sensors 28, 32, 33, 34, 36 and 37 of sensing system 16 may be mounted directly on the center of gravity of the vehicle body, along the directions x,y and z shown in FIG. 1. Sensors 28, 32, 33, 34, 36 and 37 may also be provided in an inertial measurement unit (IMU). An inertial measurement unit may include each of these sensors in a single unit or structure. As those skilled in the art will recognize, the frame from b₁,b₂ and b₃ is called a body or sensor frame 22, whose origin is located at the center of gravity of the car body, with the b₁ corresponding to the x axis pointing forward, b₂ corresponding to the y axis pointing off the driving side (to the left), and the b₃ corresponding to the z axis pointing upward. The angular rates of the car body are denoted about their respective axes as ωₓ for the roll rate, ω_{y} for the pitch rate and ω_{z} for the yaw rate. Calculations may take place in an inertial frame 24 that may be derived from the body frame 22 as described below.

The angular rate sensors and the accelerometers may be mounted on the vehicle car body along the body frame directions b₁,b₂ and b₃ which are the x-y-z axes of the sprung mass of the vehicle.

The longitudinal acceleration sensor 36 is mounted on the car body located at the center of gravity, with its sensing direction along b₁-axis, whose output is denoted as aₓ. The lateral acceleration sensor 32 is mounted on the car body located at the center of gravity, with its sensing direction along b₂-axis, whose output is denoted as a_{y}.

The other frame used in the following discussion includes the road frame, as depicted in FIG. 1. The road frame system r₁r₂r₃ is fixed on the driven road surface, where the r₃ axis is along the average road normal direction computed from the normal directions of the four-tire/road contact patches.

In the following discussion, the Euler angles of the body frame b₁b₂b₃ with respect to the road frame or moving road frame (mrf) r₁r₂r₃ are denoted as θ_{xbr} and θ_{ybr}, which are also called the relative Euler angles (i.e., relative roll and relative pitch angles, respectively).

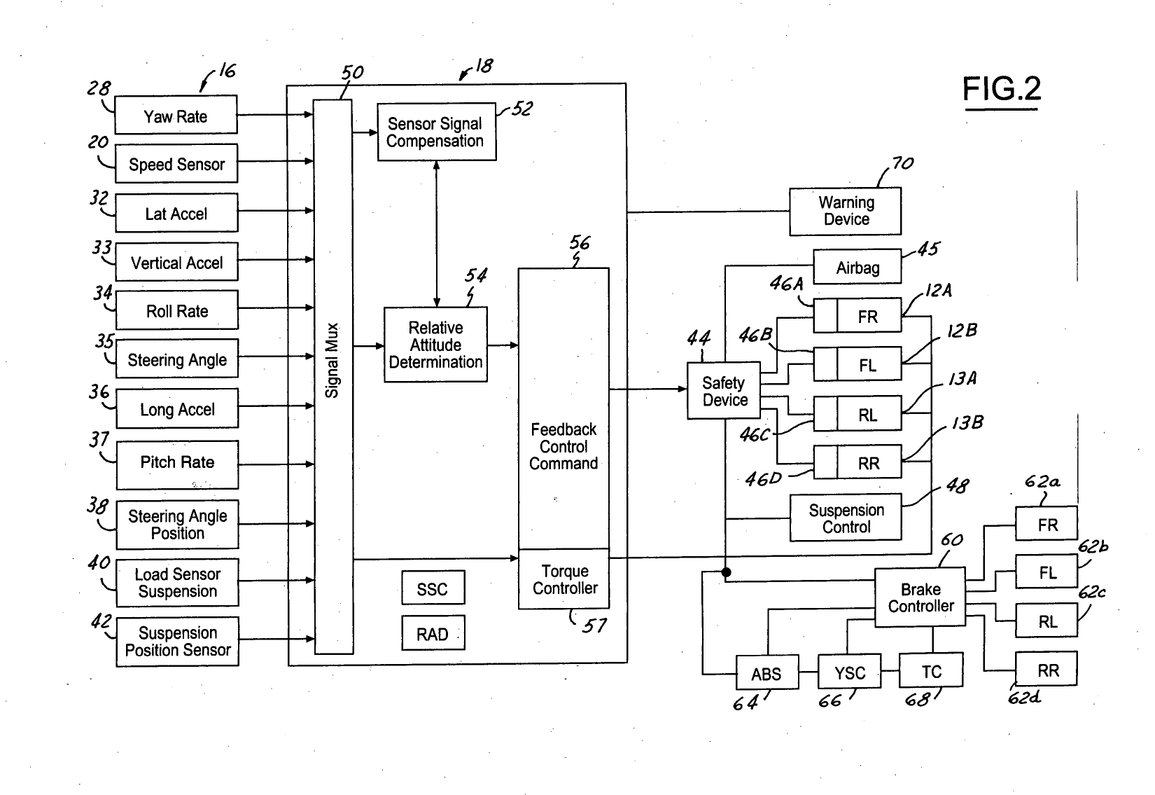

Referring now to FIG. 2, roll stability control system 18 is illustrated in further detail having a controller 26 used for receiving information from a number of sensors which may include a yaw rate sensor 28, a speed sensor 20, a lateral acceleration sensor 32, a vertical accelerometer sensor 33, a roll angular rate sensor 34, a steering wheel (hand wheel) angle sensor 35, a longitudinal acceleration sensor 36, a pitch rate sensor 37, steering angle (of the wheels or actuator) position sensor 38, suspension load sensor 40 and suspension position sensor 42. It should be noted that various combinations and sub-combinations of the sensors may be used.

Controller 26 may include a signal multiplexer 50 that is used to receive the signals from the sensors 28-42. The signal multiplexer 50 provides the signals to sensor signal compensation 52 and a relative attitude determination 54, and to a roll stability control (RSC) feedback control command 56. The relative attitude determination 54 may also be coupled to the RSC feedback command 56. The RSC feedback command 56 may include a torque controller 57. The relative attitude determination may determine roll and pitch angles described in the vehicle roll angle calculator described in U.S. Provisional Applications 60/400,376 and 60/400,172, and in U.S. patent application Ser. No. 10/459,697, the disclosures of which are incorporated herein by reference.

In the preferred embodiment, the sensors are located at the center of gravity of the vehicle. Those skilled in the art will recognize that the sensor may also be located off the center of gravity and translated equivalently thereto.

Lateral acceleration, roll orientation and speed may be obtained using a global positioning system (GPS). Based upon inputs from the sensors, controller 26 may control a safety device 44. Depending on the desired sensitivity of the system-and various other factors, not all the sensors. 28-42 may be used in a commercial embodiment. Safety device 44 may control an airbag 45 or a steering actuator 46A-46 at one or more of the wheels 12a, 12b, 13a, 13b of the vehicle. Also, other vehicle components such as a suspension control 48 may be used to adjust the suspension to prevent rollover.

The controller 26 may also be coupled to a warning device 70. The warning device 70 may be audible, visual, or a combination. The warning device 70 provides an indication of a tire abnormal state to the driver. The tire abnormal state will be described below.

Roll angular rate sensor 34 and pitch rate sensor 37 may sense the roll condition or lifting of the vehicle based on sensing the height of one or more points on the vehicle relative to the road surface. Sensors that may be used to achieve this include but are not limited to a radar-based proximity sensor, a laser-based proximity sensor and a sonar-based proximity sensor. The roll rate sensor 34 may also use a combination of sensors such as proximity sensors to make a roll rate determination.

Roll rate sensor 34 and pitch rate sensor 37 may also sense the roll condition or lifting based on sensing the linear or rotational relative displacement or displacement velocity of one or more of the suspension chassis components. This may be in addition to or in combination with suspension position sensor 42. The position sensor 42, roll rate sensor 34 and/or the pitch rate sensor 37 may include a linear height or travel sensor, a rotary height or travel sensor, a wheel speed sensor used to look for a change in velocity, a steering wheel position sensor, a steering wheel velocity sensor and a driver heading command input from an electronic component that may include steer by wire using a hand wheel or joy stick.

The roll condition or lifting may also be sensed by sensing directly or estimating the force or torque associated with the loading condition of one or more suspension or chassis components including a pressure transducer in an act of air suspension, a shock absorber sensor such as a load sensor 40, a strain gauge, the steering system absolute or relative motor load, the steering system pressure of the hydraulic lines, a tire laterally force sensor or sensors, a longitudinal tire force sensor, a vertical tire force sensor or a tire sidewall torsion sensor. The yaw rate sensor 28, the roll rate sensor 34, the lateral acceleration sensor 32, and the longitudinal acceleration sensor 36 may be used together to determine that the wheel has lifted. Such sensors may be used to determine wheel lift or estimate normal loading associated with wheel lift.

The roll condition of the vehicle may also be established by one or more of the following translational or rotational positions, velocities or accelerations of the vehicle including a roll gyro, the roll rate sensor 34, the yaw rate sensor 28, the lateral acceleration sensor 32, the vertical acceleration sensor 33, a vehicle longitudinal acceleration sensor 36, lateral or vertical speed sensor including a wheel-based speed sensor 20, a radar-based speed sensor, a sonar-based speed sensor, a laser-based speed sensor or an optical-based speed sensor.

Safety device 44 may control the position of the front right wheel actuator 46A, the front left wheel actuator 46B, the rear left wheel actuator 46C, and the right rear wheel actuator 46D. Although as described above, two or more of the actuators may be simultaneously controlled. For example, in a rack-and-pinion system, the two wheels coupled thereto are simultaneously controlled. Based on the inputs from sensors 28 through 42, controller 26 determines a roll condition and/or wheel lift and controls the steering position and/or braking of the wheels.

Safety device 44 may be coupled to a brake controller 60. Brake controller 60 controls the amount of brake torque at a front right brake 62a, front left brake 62b, rear left brake 62c and a rear right brake 62d. Other safety systems such as an antilock brake system 64, a yaw stability control system 66 and a traction control system 68 may also benefit from the knowledge of the roll gradient, roll rate parameter, roll acceleration coefficient, additional mass and position of the mass. This information may impact the control strategy such as an amount of braking may be modified.

Speed sensor 20 may be one of a variety of speed sensors known to those skilled in the art. For example, a suitable speed sensor may include a sensor at every wheel that is averaged by controller 26. The controller 26 may translate the wheel speeds into the speed of the vehicle. Yaw rate, steering angle, wheel speed and possibly a slip angle estimate at each wheel may be translated back to the speed of the vehicle at the center of gravity. Various other algorithms are known to those skilled in the art. Speed may also be obtained from a transmission sensor. For example, if speed is determined while speeding up or braking around a corner, the lowest or highest wheel speed may not be used because of its error. Also, a transmission sensor may be used to determine vehicle speed.

Load sensor 40 may be a load cell coupled to one or more suspension components. By measuring the stress, strain or weight on the load sensor a shifting of the load can be determined.

The roll condition of a vehicle can be characterized by the relative roll angle between the vehicle body and the wheel axle and the wheel departure angle (between the wheel axle and the average road surface). Both the relative roll angle and the wheel departure angle may be calculated in relative roll angle estimation module by using the roll rate and lateral acceleration sensor signals. If both the relative roll angle and the wheel departure angles are large enough, the vehicle may be in either single wheel lifting or double wheel lifting. On the other hand, if the magnitude of both angles is small enough, the wheels are likely all grounded. In case that both of them are not small and the double wheel lifting condition is detected or determined, the sum of those two angles will be used by the feedback control module to compute the desired actuation command for achieving rollover control performance.

The roll condition of a vehicle can be characterized by rolling radius-based wheel departure roll angle, which captures the angle between the wheel axle and the average road surface through the dynamic rolling radii of the left and right wheels when both of the wheels are grounded. Since the computation of the rolling radius is related to the wheel speed and the linear velocity of the wheel, such rolling-radius based wheel departure angle will assume abnormal values when there are large wheel slips. This happens when a wheel is lifted and there is torque applied to the wheel. Therefore, if this rolling radius-based wheel departure angle is increasing rapidly, the vehicle might have lifted wheels. Small magnitude of this angle indicates the wheels are all grounded.

The roll condition of the vehicle can be seen indirectly from the wheel longitudinal slip. If during a normal braking or driving torque the wheels at one side of the vehicle experience increased magnitude of slip, then the wheels of that side are losing longitudinal road torque. This implies that the wheels are either driven on a low mu surface or lifted up. The low mu surface condition and wheel-lifted-up condition can be further differentiated based on the chassis roll angle computation, i.e., in low mu surface, the chassis roll angle is usually very small. Hence, an accurate determination of chassis roll is desired.

The roll condition of the vehicle can be characterized by the normal loading sustained at each wheel. Theoretically, when a normal loading at a wheel decreases to zero, the wheel is no longer contacting the road surface. In this case a potential rollover is underway. Large magnitude of this loading indicates that the wheel is grounded. Normal loading is a function of the calculated chassis roll and pitch angles. Hence, an accurate determination of chassis roll and pitch angles is desired.

The roll condition can be identified by checking the actual road torques applied to the wheels and the road torques, which are needed to sustain the wheels when they are grounded. The actual road torques can be obtained through torque balancing for each wheel using wheel acceleration, driving torque and braking torque. If the wheel is contacting the road surface, the calculated actual road torques must match or be larger than the torques determined from the nonlinear torques calculated from the normal loading and the longitudinal slip at each wheel.

The roll condition of a vehicle can be characterized by the chassis roll angle itself, i.e., the relative roll angle θₓᵣ between the vehicle body and the wheel axle. If this chassis roll angle is increasing rapidly, the vehicle might be on the edge of wheel lifting or rollover. Small magnitude of this angle indicates the wheels are not lifted or are all grounded. Hence, an accurate determination of the chassis roll angle is beneficial for determining if the vehicle is in non-rollover events.

The roll condition of a vehicle can also be characterized by the roll angle between the wheel axle and the average road surface, this is called wheel departure angle. If the roll angle is increasing rapidly, the vehicle has lifted wheel or wheels and aggressive control action needs to be taken in order to prevent the vehicle from rolling over. Small magnitude of this angle indicates the wheels are not lifted.

The center of gravity C is also illustrated with nominal mass M. A roll axis is also illustrated at a distance D from the center of gravity. The variable a_{y} is the lateral acceleration.

Referring now to FIG. 3, the relationship of the various angles of the vehicle 10 relative to the road surface 11 is illustrated. In the following, a reference road bank angle θ_{bank} is shown relative to the vehicle 10 on a road surface. The vehicle has a vehicle body 10a and wheel axle 10b. The wheel departure angle θ_{wda} is the angle between the wheel axle and the road. The relative roll angle θₓᵣ is the angle between the wheel axle 10b and the body 10a. The global roll angle θₓ is the angle between the horizontal plane (e.g., at sea level) and the vehicle body 10a.

Another angle of importance is the linear bank angle. The linear bank angle is a bank angle that is calculated more frequently (perhaps in every loop) by subtracting the relative roll angle generated from a linear roll dynamics of a vehicle (see U.S. Pat. No. 6,556,908 which is incorporated by reference herein), from the calculated global roll angle (as the one in U.S. Pat. No. 6,799,092, which is incorporated by reference herein). If all things were slowly changing without drifts, errors or the like, the linear bank angle and reference road bank angle terms would be equivalent.

Referring now to FIG. 4, the vehicle 10 is illustrated on a slope θ_{pitch}.

### Tire Parameter Determination Methods

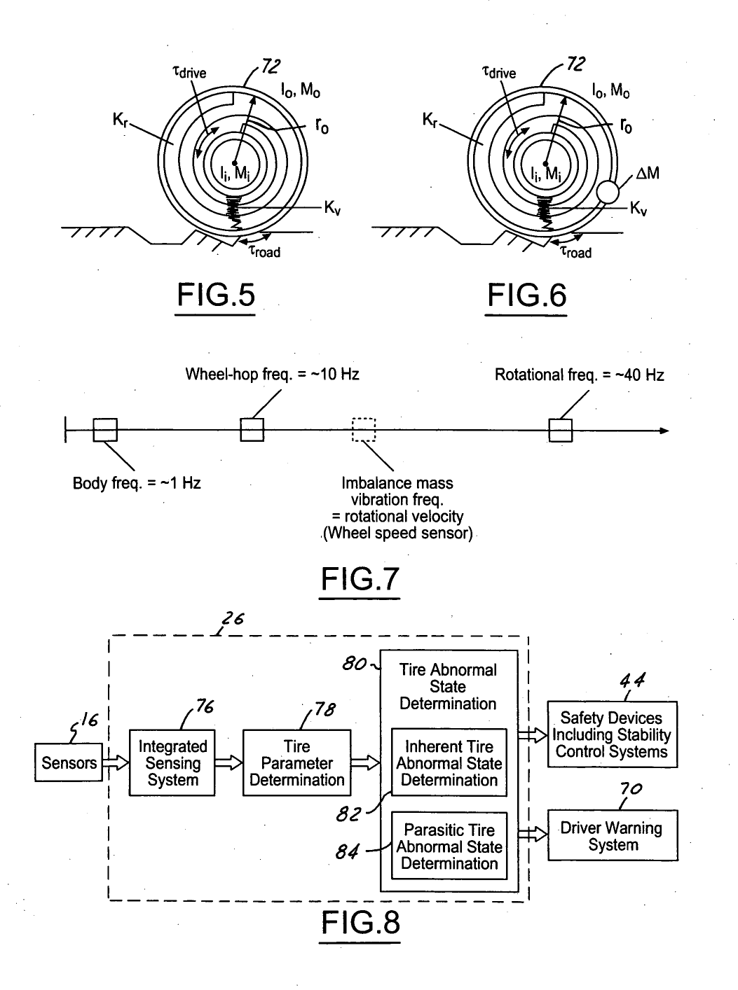

Referring now to FIG. 5, the motion variables of a tire 72 in a moving vehicle are illustrated. These variables can be determined through the tire parameters such as the steady-state tire rolling radius rₒ, the tire longitudinal, lateral and vertical spring rate Kᵥ, the tire rotational spring rate Kᵣ, etc. The parameters are related to the structure and the material of the tire. In a vehicle control system, the tire parameters which could change due to different operating conditions and time length of usage are of interest.

It is a well known that the tire spring rates are related to the tire air pressures. Low tire pressure may cause changes in the tire rotational and vertical spring rates. FIG. 5 illustrates a two-piece model of a tire/wheel assembly, where the inner mass mᵢ includes the half shaft and the wheel hub. The tire is modeled as an outer mass mₒ. The spring rates of the tire Kᵥ, Kᵣ are inserted in between the inner piece and the outer piece such that they can be used to model the tire function.

FIG. 6 shows a tire/wheel assembly where there is an imbalanced weight Δm attached to the outer piece. Notice that this modeling of the imbalanced tire is general. If an imbalance occurs in the inner piece, for example, a transformation can be easily done by moving that imbalance to the outer piece. The dynamic effect of these two cases is equivalent.

Referring now to FIG. 7, the frequency regions of the involved motion of the tire and the vehicle body may be briefly summarized. That is, the motion at the point of the vehicle body where the suspension is connected (the so-called vehicle body motion variable) is usually around 1 Hz region (called the body frequency), the frequency of the tire vertical motion is around 10 Hz (called the wheel hop frequency), the frequency of the tire rotational motion is around 40 Hz for a tire with full air pressure. The tire imbalanced mass causes a motion in vertical direction of the tire/wheel assembly with the frequency equal to the wheel rotational speed, which is measured by the ABS wheel speed sensor.

Referring now to FIG. 8, controller 26 is illustrated in further detail. Sensors 16 are coupled to an integrated sensing system (ISS) 76, which in turn is coupled to the tire parameter determination 78. The tire parameter determination 78 is coupled to a tire abnormal state determination, which includes an inherent tire abnormal state determination 82 and a parasitic tire abnormal state determination 84. The tire abnormal state determination may be used to control a safety device including a stability control system 44 and a driver warning system 70. The integrated sensing system 76 may include various sensors such as the yaw rate sensor 28, the lateral acceleration sensor 32, the vertical acceleration sensor 33, the roll rate sensor 34, the longitudinal acceleration sensor 36, and the pitch rate sensor 37. The integrated sensing system may also determine a relative roll angle and a relative pitch angle as described above.

The tire parameters determined in tire parameter determination 78 that may be used in the tire abnormal determination 80 include but are not limited to steady-state rolling radius of the tire, rotational spring rate of the tire, vertical spring rate of the tire, and imbalance strength of the tire.

Not all of the tire parameters are required for each of the abnormal determinations. Specific examples are set forth below.

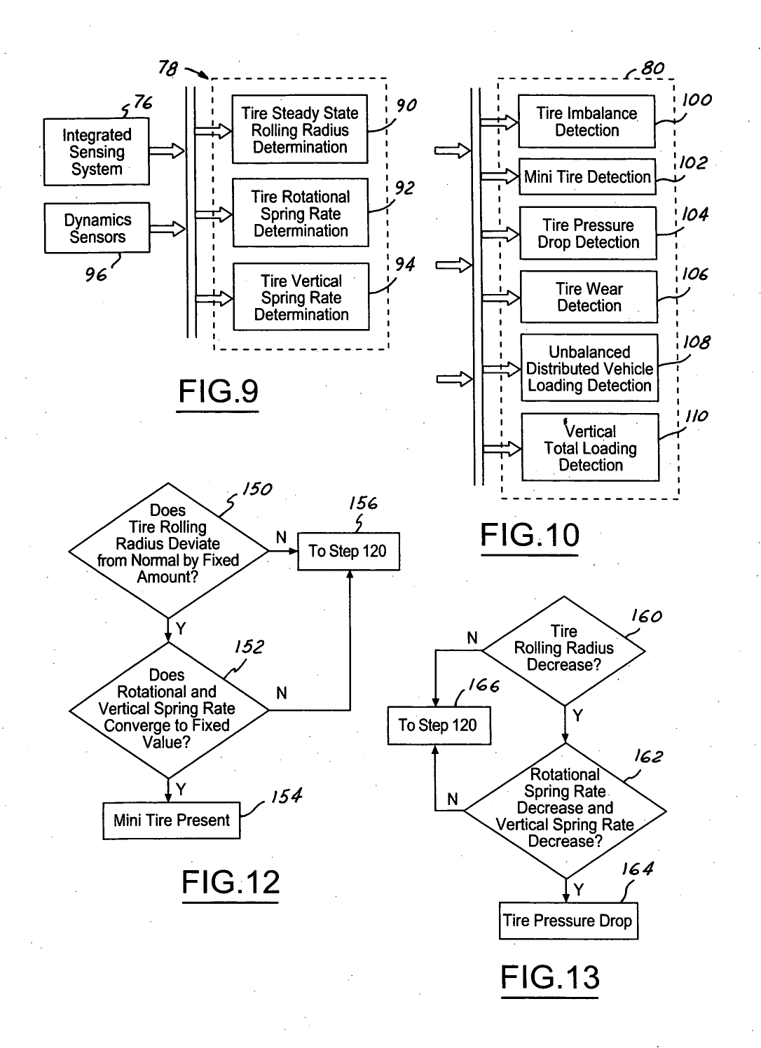

Referring now to FIG. 9, the tire parameter determination 78 is illustrated in further detail. The tire parameter determination 78 may include the tire steady state rolling radius determination 90, the tire rotational spring rate determination 92, the tire vertical spring rate determination 94. Inputs to block 78 may include the integrated sensing system 76 and the dynamic sensors 96. The dynamic sensors 96 may include various dynamic sensors including the speed sensors 20, the steering angle sensor 34, the steering angle position 38, the load sensor on the suspension 40, and the suspension position sensor 42.

Referring now to FIG. 10, the tire abnormal state determination 82 may include a tire imbalance detection 100, a mini tire detection 102, a tire pressure drop detection 104, a tire wear detection 106, an unbalanced distributed vehicle loading detection 108, and a vehicle load detection 110. It should be noted that one or all of the detections 100 through 110 may be performed by the system.

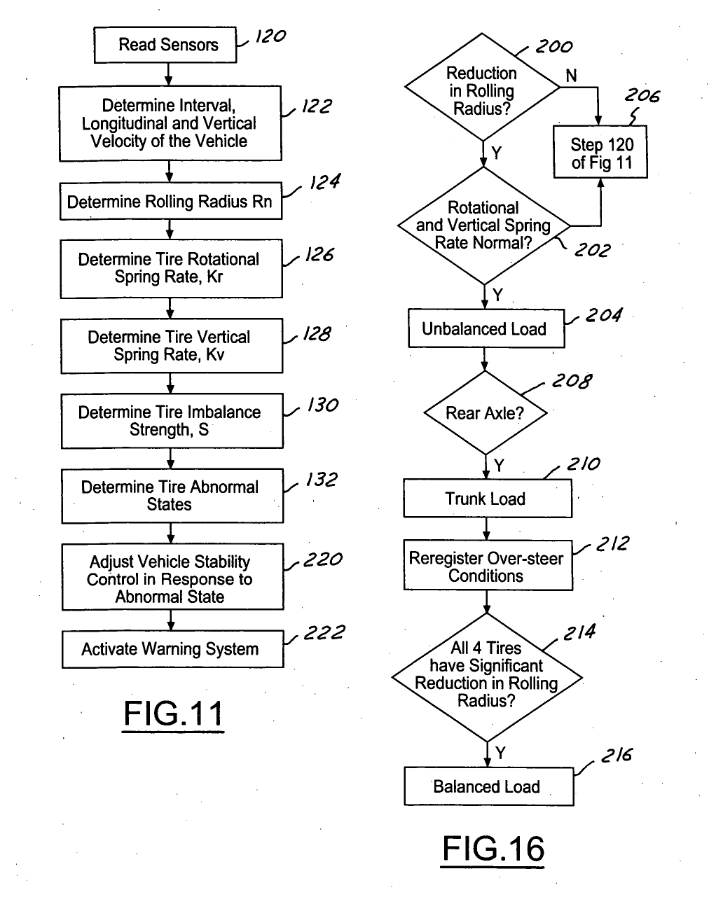

Referring now to FIG. 11, the various sensors of the system are read. In step 122, the calculated variables are determined in the ISS sensing module and include the sensor-frame velocities of the vehicle body including the longitudinal velocity vₓ^{ISS}, the lateral velocity v_{y}^{ISS} and the vertical velocity v_{z}^{ISS}.

The variable wₛᵢ is the ith wheel speed sensor output for i=0,1,2,3 (corresponding to front left, front right, rear left and rear right wheel respectively). Notice that wₛ₀, wₛ₁, wₛ₂ and wₛ₃ are related to the rotational speeds of wheels through the gains which reflect the static rolling radii of the wheels. The rotation speeds are defined along the longitudinal directions of the wheels.

Using the calculated vehicle longitudinal and lateral velocities from ISS 76, and the kinematical relationships of the calculated signals and the measured signals, the longitudinal and lateral velocities at the spindles of the wheels but along the sensor frame's x, y and z axes can be expressed as in the following:
vₓ₀^{SF}=vₓ^{ISS}−ωhd zst_{f}, v_{y0}^{SF}=v_{y}^{ISS}+ω_{zs}b_{f}, v_{z0}^{SF}=v_{z}^{ISS}+ωₓₛt_{f}−ω_{ys}b_{f},
vₓ₁^{SF}=vₓ^{ISS}=ω_{zs}t_{f}, v_{y1}^{SF}=v_{y}^{ISS}+ω_{zs}b_{f}, v_{z1}^{SF}=v_{z}^{ISS}−ωₓₛt_{f}−ω_{ys}b_{f},
vₓ₂^{SF}=vₓ^{ISS}−ω_{zs}tᵣ, v_{y2}^{SF}=v_{y}^{ISS}+ω_{zs}bᵣ, v_{z2}^{SF}=v_{z}^{ISS}+ωₓₛtᵣ+ω_{ys}bᵣ,
vₓ₃^{SF}=vₓ^{ISS}+ω_{zs}tᵣ, v_{y3}^{SF}=v_{y}^{ISS}+ω_{zs}bᵣ, v_{z3}^{SF}=v_{z}^{ISS}−ωₓₛtᵣ+ω_{ys}bᵣ, (1)
where t_{f} and tᵣ are the half tracks at the front and rear axle respectively, b_{f} and bᵣ are the distances from the sensor location to the front and rear axle respectively.

When the vehicle is turning or braking, the vehicle body has a slight tilt with respect to the road. Hence, the wheel speed sensor signals are usually different from the calculated variables in Equation (1). These differences can be eliminated by using the relative attitudes calculated in the RAD unit and the sensor misalignments calculated in the SSC unit. The relative roll and pitch angles as θₓᵣ,θ_{yr} and the sensor misalignment from the sensor frame to the vehicle body frame are Δθ_{xsb},Δθ_{ysb},Δθ_{zsb}, respectively, then through Euler transformation, the velocities at the spindles along the moving road-frame (MRF) can be determined as in the following:
vₓᵢ^{MRF}=Eulertfₓ(vₓᵢ^{SF}, v_{yi}^{SF}, v_{zi}^{SF},θₓᵣ+Δθ_{xsb},θ_{yr}+Δθ_{ysb},Δθ_{zsb})
v_{yi}^{MRF}=Eulertf_{y}(vₓᵢ^{SF}, v_{yi}^{SF}, v_{zi}^{SF},θₓᵣ+Δθ_{xsb},θ_{yr}+Δθ_{ysb},Δθ_{zsb})
v_{zi}^{MRF}=Eulertf_{z}(vₓᵢ^{SF}, v_{yi}^{SF}, v_{zi}^{SF},θₓᵣ+Δθ_{xsb},θ_{yr}+Δθ_{ysb},Δθ_{zsb}) (2)
for i=0,1,2,3 (corresponding to front left, front right, rear left and rear right wheel, respectively). Later the integration of moving road references may be referred to as Z_{b}, which is the vertical displacement of the point on the vehicle body where the suspension is, connected thereto. Then, the following wheel longitudinal velocities for a front steering vehicle are:
v₀^{MRF}=vₓ₀^{MRF} cos δ_{f}+v_{y0}^{MRF} sin δ_{f}
v₁^{MRF}=vₓ₁^{MRF} cos δ_{f}+v_{y1}^{MRF} sin δ_{f}
v₂^{MRF}=vₓ₂^{MRF}
v₃^{MRF}=vₓ₃^{MRF} (3)
or the following for a rear steering vehicle
v₀^{MRF}=vₓ₀^{MRF}
v₁^{MRF}=vₓ₁^{MRF}
v₂^{MRF}=vₓ₂^{MRF} cos δᵣ+v_{y2}^{MRF} sin δᵣ
v₃^{MRF}=vₓ₃^{MRF} cos δᵣ+v_{y3}^{MRF} sin δᵣ (4)
or the following for a four wheel steering vehicle
v₀^{MRF}=vₓ₀^{MRF} cos δ_{f}+v_{y0}^{MRF} sin δ_{f}
v₁^{MRF}=vₓ₁^{MRF} cos δ_{f}+v_{y1}^{MRF} sin δ_{f}
v₂^{MRF}=vₓ₂^{MRF} cos δᵣ+v_{y2}^{MRF} sin δᵣ
v₃^{MRF}=vₓ₃^{MRF} cos δᵣ+v_{y3}^{MRF} sin δᵣ (5)

### Tire Rolling Radius Identification

From the above variables, the tire rolling radius may be determined in step 124. The computation of Equation (5) may also be expressed as the following for the ith wheel

$${v}_{i}^{MRF} = {v}_{cpi} + \frac{{w}_{si}}{{r}_{0 i}} {r}_{i} \qquad ( 6 )$$

where v_{cpi} is the sliding velocity of the contact patch between the ith wheel and the road, wₛᵢ is the wheel speed sensor signal, and r₀ᵢ is the nominal rolling radius of the ith wheel, and rᵢ is the steady state rolling radius of the ith wheel.

If the wheels are all rolling without slipping, based on Equations (5) and (6), the steady state rolling radius rᵢ of the ith wheel can be calculated as:

$${r}_{i} = \frac{{r}_{0 i}}{{w}_{si}} {v}_{i}^{MRF} . \qquad ( 7 )$$

For robust implementation, the steady state rolling radius is calculated by averaging the rᵢ value over a long period of time when the driving conditions permit the determination. Such driving conditions are called the screening conditions. If the number of samples in the averaging process is N, then the following algorithm is performed:

$${R}_{n} = {R}_{n - 1} + \frac{{r}_{0 i}}{{N ( {w}_{si} )}_{k}} {( {v}_{i}^{MRF} )}_{k} ; \\ {R}_{n} = min ( \overline{R} , max ( \underline{R} , {R}_{n} ) ) ; \\ n = n + 1 ; \qquad ( 8 )$$

where the subscript k indicates the current time instant of the regular samples, the subscript n indicates the current time instant when the screening condition is satisfied, the subscript n−1 indicates the past time instant when the screening condition is satisfied, R and \overline{R} are the lower and upper bounds of the rolling radius. When the averaging achieves N, the final steady state rolling radius of the ith wheel can be further obtained as in the following:

if (n = N)
{

| | |
|---|---|
| rᵢ = Rₙ; | (9) |
| n = 0; | |
| Rₙ = 0; | |

}

With the above calculated rolling radius, the compensated wheel speed sensor signals can be expressed as:

$${w}_{si}^{c} = \frac{{w}_{si}}{{r}_{0 i}} {r}_{i} . \qquad ( 10 )$$

The screening conditions used in the above computations might include multiple conditions. For example, one screening condition for activating the computation of the steady state rolling radius may be that the ith wheel does not experience vertical oscillation, i.e., the ith wheel taking-off angle

$${α}_{i} = {tan}^{- 1} ( \frac{{v}_{zi}^{MRF}}{{v}_{xi}^{MRF}} ) \qquad ( 11 )$$

is very small, or the wheel is well contacted with the road surface, or the wheel is not driven on a rough road, gravel road or off-road.

Another screening condition for activating the computation of the steady state rolling radius might be that the wheel is not slipping in longitudinal direction, which can be determined by comparing the following longitudinal slip ratio with a threshold:

$${s}_{i} = \frac{{v}_{xi}^{MRF} - {w}_{i}^{c}}{{v}_{xi}^{MRF}} . \qquad ( 12 )$$

Yet another screening condition for activating the computation of the steady state rolling radius might be that the tire is not being applied to large driving/braking torques, which can be calculated based on the braking pressure and the driving torque from the powertrain.

### Tire Rotational Spring Rate Identification

In step 126 the tire rotational spring rate may be determined. The tire and wheel assembly shown in FIGS. 5 and 6 is modeled as a two-piece system: an outer mass for the tire and an inner mass for the half axle and wheel hub. In order to simplify the description, the subscript used to differentiate the wheels at the four corners of the vehicle has been removed. That is, in the following discussion, all the algorithms are equally applicable to the four wheels.

The variables Iₒ and Iᵢ are the rolling momentum inertias of the inner and outer masses. The air in the tire generates elasticity effects in between the inner and outer masses along the rotational, vertical and lateral directions. Such elasticity effects are modeled with a rotational spring with spring rate Kᵣ and a vertical spring with spring rate Kᵥ. There is a torque τ_{road} applied to the outer piece from the road and a driving torque τ_{drive} applied to the inner piece from the power. The wheel speed sensor measures the rotation speed between the inner and the out masses.

If the rotational damping between the inner and the outer mass is Dᵣ, by using Newton's law, the rotational acceleration of the outer mass may be calculated as:

$${A}_{outer} = \frac{{τ}_{road} + {K}_{r} {\int }_{0}^{t} \frac{{w}_{s}}{{r}_{0}} ⅆ t + {D}_{r} \frac{{w}_{s}}{{r}_{0}}}{{I}_{o}} \qquad ( 13 )$$

and the rotational acceleration of the inner mass may be calculated as

$${A}_{inner} = \frac{{τ}_{drive} - {K}_{r} {\int }_{0}^{t} \frac{{w}_{s}}{{r}_{0}} ⅆ t - {D}_{r} \frac{{w}_{s}}{{r}_{0}}}{{I}_{i}} \qquad ( 14 )$$

where wₛ is the wheel speed sensor output and r₀ is the nominal rolling radius of the tire.

Since the difference between the rotational accelerations of the inner mass and the outer mass is the same as the derivative of the wheel speed sensor signals, the following dynamic relationship may be developed:

$${\dot{w}}_{s} = {r}_{0} [ \frac{{τ}_{drive}}{{I}_{i}} - \frac{{τ}_{road}}{{I}_{o}} ] - [ ( \frac{1}{{I}_{o}} + \frac{1}{{I}_{i}} ) {D}_{r} {w}_{s} + ( \frac{1}{{I}_{o}} + \frac{1}{{I}_{i}} ) {K}_{r} {\int }_{0}^{t} {w}_{s} ⅆ t ] . \qquad ( 15 )$$

Consider a band-pass filter B with its center frequency around 40 Hz. For example, one of such filter of the fourth order can be described as the following in z-transform:

$$B ( z ) = \frac{{n}_{1} {z}^{4} - {n}_{2} {z}^{3} + {n}_{3} {z}^{2} - {n}_{2} z + {n}_{1}}{{z}^{4} - {d}_{1} {z}^{3} + {d}_{2} {z}^{2} - {d}_{3} z + {d}_{4}} \qquad ( 16 )$$

and consider another washout integration filter T. For example, one of such filter of the first order can be described as the following in z-transform

$$T ( z ) = \frac{{n}_{5} z + {n}_{5}}{z - {d}_{5}} \qquad ( 17 )$$

with properly chosen filter coefficients nᵢ and dᵢ for i=1,2, . . . , 5. T(z)=1 may be set so that there is no integration in the wheel speed signals and the computation will still be valid since when differentiating Equation (14), a similar equation is true except that

$${r}_{0} [ \frac{{τ}_{drive}}{{I}_{i}} - \frac{{τ}_{road}}{{I}_{o}} ]$$

in Equation (14) will be replaced by

$${r}_{0} [ \frac{{\dot{τ}}_{drive}}{{I}_{i}} - \frac{{\dot{τ}}_{road}}{{I}_{o}} ] .$$

The signal generated by passing the wheel speed sensor signal wₛ through these two filters in Equations (14) and (15) sequentially is a signal which is the integral of the wheel speed sensor signal but with frequency contents limited to the frequency interval defined by the band-pass filter B. That signal is wₛ^{f}, i.e., in z-domain:
wₛ^{f}=B(z)T(z)wₛ (18)

Such a signal wₛ^{f} in Equation (18) is the signal with frequency contents limited within the frequency interval filter defined by the band-pass filter.

The variables needed to conduct tire rotational spring rate determination are determined. The specific method of interest is the two parameter conditional least square (CLS) method.

Let N be the total number of samples in the least square method. The following cumulative sums are determined when the screening condition for determining tire rotational spring rate is satisfied and the number of the samples used is less than the total number N of the samples

if ( screening condition is satisfied & n ≦ N )
{

| a₁₁_{ₙ₊₁} = a₁₁_{ₙ} + (wₛ^{f})ₖ₋₁(wₛ^{f})ₖ₋₁ | |
|---|---|
| a₂₁_{ₙ₊₁} = a₂₁_{ₙ} + (wₛ^{f})ₖ₋₁(wₛ^{f})ₖ₋₂ | |
| a₂₂_{ₙ₊₁} = a₂₂_{ₙ} + (wₛ^{f})ₖ₋₂(wₛ^{f})ₖ₋₂ | (19) |
| b₁_{ₙ₊₁} = b₁_{ₙ} + (wₛ^{f})ₖ₋₁(wₛ^{f})ₖ | |
| b₂_{ₙ₊₁} = b₂_{ₙ} + (wₛ^{f})ₖ₋₂(wₛ^{f})ₖ | |
| n = n + 1 | |

}

where the subscript k,k−1 and k−2 indicate the current, the first past and the second past time instant, or the timing kΔT, (k−1)ΔT and (k−2)ΔT with ΔT being the sampling time.

As the cumulative sums collect N samples, the following computation generates two intermediate parameters θ₁ and θ₂. In the algorithm aₘᵢₙ is used to bound other intermediate variables such as D_{θ}and a₂₂_{_{N}}. θ₁ is limited within the lower bound θ₁ and the upper bound \overline{θ}₁, and θ₂ is limited within the lower bound θ₂ and the upper bound \overline{θ}₂.

$${D}_{θ} = min ( max ( {a}_{{11}_{n}} - \frac{{a}_{{21}_{N}}^{2}}{max ( {a}_{{22}_{n}} , {a}_{min} )} , - {a}_{min} ) , {a}_{min} ) ; \\ {θ}_{1} = min ( max ( ( {b}_{{1}_{n}} - \frac{{a}_{{21}_{N}} {b}_{{2}_{n}}}{max ( {a}_{{22}_{n}} , {a}_{min} )} ) {D}_{θ}^{- 1} , {\underline{θ}}_{1} ) , {\overline{θ}}_{1} ) ; \\ {θ}_{2} = min ( max ( ( \frac{{a}_{{11}_{n}} {b}_{{2}_{n}}}{max ( {a}_{{22}_{n}} , {a}_{min} )} - \frac{{a}_{{21}_{n}} {b}_{{2}_{n}}}{max ( {a}_{{22}_{n}} , {a}_{min} )} ) {D}_{θ}^{- 1} , {\underline{θ}}_{2} ) , {\overline{θ}}_{2} ) ; . \\ n = 0 ; \\ {a}_{{11}_{n}} = 0 ; {a}_{{21}_{n}} = 0 ; {a}_{{22}_{n}} = 0 ; \\ {b}_{{1}_{n}} = 0 ; {b}_{{2}_{n}} = 0 ; \qquad ( 20 )$$

After θ₁ and θ₂ are calculated, the tire rotational spring rate Kᵣ is ready to be determined through the following algorithm:

$${λ}_{R} = \frac{{θ}_{1}}{2} ; \\ {λ}_{I} = \frac{\sqrt{- {θ}_{1}^{2} - 4 {θ}_{2}}}{2} ; \\ {λ}_{mag} = \sqrt{{λ}_{R}^{2} + {λ}_{I}^{2}} ; \\ Θ = a tan 2 ( {λ}_{I} , {λ}_{R} ) ; \\ {K}_{r} = \frac{{I}_{i} {I}_{o}}{{I}_{i} + {I}_{o}} \frac{( {log ( {λ}_{mag} )}^{2} + {Θ}^{2}}{4 {π}^{2} Δ T} ; \\ {K}_{r} = min ( max ( {K}_{r} , {\underline{K}}_{r} ) , {\overline{K}}_{r} ) ; \qquad ( 21 )$$

where ΔT is the sampling time used, for example, ΔT=2 ms.

### Tire Vertical Spring Rate Identification

In step 128 the tire vertical spring rate is determined in step 128. A vertical dynamics of the tire/wheel assembly can be similarly modeled as the rotational dynamics were performed above in step 126. The inner piece has a mass Mᵢ and the outer piece has a mass Mₒ. The variable zₛₕ is the suspension height, which is measured by a suspension height sensor, and z_{td} being the tire vertical deflection due to air compression (the vertical stiffness Kᵥ). The vertical acceleration of the inner mass can be computed by balancing the vertical forces applied to the tire, namely, the suspension force and the tire normal force, as in the following:

$${A}_{v - inner} = \frac{{K}_{s} {z}_{sh} + {D}_{s} {\dot{z}}_{sh} - {K}_{v} {z}_{td} - {D}_{v} {\dot{z}}_{td}}{{M}_{i}} . \qquad ( 22 )$$

The variable z_{b} is the vertical displacement of the point on the vehicle body where the suspension is connected. The vehicle state variables may be calculated in the ISS system. If the wheel of interest is the ith wheel, then z_{bi} can be obtained by integrating the vertical velocity v_{zi}^{SF} as calculated in Equation (1).

The vertical acceleration of the inner mass may be. alternatively described using z_{b} and the suspension height zₛₕ as:
Aᵥ₋ᵢₙₙₑᵣ=\ddot{z}_{b}−\ddot{z}ₛₕ (23)
and the tire deflection z_{td} can be determined as
z_{td}=z_{b}−zₛₕ−v (24)

Therefore:

$${\ddot{z}}_{sh} + \frac{{D}_{v} + {D}_{s}}{{M}_{i}} {\dot{z}}_{sh} + \frac{{K}_{v} + {K}_{s}}{{M}_{i}} {z}_{sh} = [ {\ddot{z}}_{b} + \frac{{K}_{s}}{{M}_{i}} {z}_{b} + \frac{{D}_{s}}{{M}_{i}} {\dot{z}}_{b} ] - [ \frac{{K}_{v}}{{M}_{i}} v + \frac{{D}_{v}}{{M}_{i}} \dot{v} ] \qquad ( 25 )$$

where v is the vertical road profile.

Since Equation (25) is true for specific frequency range, hence it is true for some band-pass filtered signals. Let B′ be a band-pass filter and denote the signal generated by passing the suspension height through this filter as zₛₕ^{f}, i.e., in z-domain:
zₛₕ^{f}=B′(z)zₛₕ (26)
then such a filtered signals must satisfy the following equation:

$${\ddot{z}}_{sh}^{f} + \frac{{D}_{v} + {D}_{s}}{{M}_{i}} {\dot{z}}_{sh}^{f} + \frac{{K}_{v} + {K}_{s}}{{M}_{i}} {\ddot{z}}_{sh}^{f} = B ( z ) [ {\ddot{z}}_{b} + \frac{{K}_{s}}{{M}_{i}} {z}_{b} + \frac{{D}_{s}}{{M}_{i}} {\dot{z}}_{b} ] - B ( z ) [ \frac{{K}_{v}}{{M}_{i}} v + \frac{{D}_{v}}{{M}_{i}} \dot{v} ] . \qquad ( 27 )$$

The vertical road profile v is a random variable, whose averaging effect can be thought around zero, hence from a long term point of view, it may be assumed that:

$$B ( z ) [ \frac{{K}_{v}}{{M}_{i}} v + \frac{{D}_{v}}{{M}_{i}} \dot{v} ] \approx 0. \qquad ( 28 )$$

That is, the following is true for the long term:

$${\ddot{z}}_{sh}^{f} + \frac{{D}_{v} + {D}_{s}}{{M}_{i}} {\dot{z}}_{sh}^{f} + \frac{{K}_{v} + {K}_{s}}{{M}_{i}} {\ddot{z}}_{sh}^{f} = B ( z ) [ {\ddot{z}}_{b} + \frac{{K}_{s}}{{M}_{i}} {z}_{b} + \frac{{D}_{s}}{{M}_{i}} {\dot{z}}_{b} ] . \qquad ( 29 )$$

Consider in each time instant k, the above equation might be expressed as:
(zₛₕ^{f})ₖ+φ₁(zₛₕ^{f})ₖ₋₁+φ₂(zₛₕ^{f})ₖ₋₂=fₖ₋₁(\ddot{z}_{b},\dot{z}_{b},z_{b}) (30)

and the two unknown parameters may be determined through the following two parameter conditional least square method. The variable N is the total number of samples in the least square method. First, the following cumulative sum is determined when the screening condition for determining tire vertical spring rate is satisfied and the number of the samples used is less than the total number N of the samples:

if ( screening condition is satisfied & n ≦ N )
{

| c₁₁_{ₙ₊₁} = c₁₁_{ₙ} +(zₛₕ^{f})ₖ₋₁(zₛₕ^{f})ₖ₋₁ | |
|---|---|
| c₂₁_{ₙ₊₁} = c₂₁_{ₙ} +(zₛₕ^{f})ₖ₋₁(zₛₕ^{f})ₖ₋₂ | |
| c₂₂_{ₙ₊₁} = c₂₂_{ₙ} +(zₛₕ^{f})ₖ₋₂(zₛₕ^{f})ₖ₋₂ | (31) |
| d₁_{ₙ₊₁} = d₁_{ₙ} +[(zₛₕ^{f})ₖ − fₖ₋₁](zₛₕ^{f})ₖ₋₁ | |
| d₂_{ₙ₊₁} = d₂_{ₙ} +[(zₛₕ^{f})ₖ − fₖ₋₁](zₛₕ^{f})ₖ₋₂ | |
| n = n + 1 | |

}

As the cumulative sums collect N samples, the following computation generates two intermediate parameters φ₁ and φ₂. In the algorithm cₘᵢₙ used to bound some other intermediate variables such as D_{φ}and c₂₂_{_{N}}. φ₁ is limited within the lower bound φ₁ and the upper bound \overline{φ}₁, and φ₂ is limited within the lower bound φ₂ and the upper bound \overline{φ}₂.

$${D}_{φ} = min ( max ( {c}_{{11}_{n}} - \frac{{c}_{{21}_{n}}^{2}}{max ( {c}_{{22}_{n}} , {c}_{min} )} , - {c}_{min} ) , {c}_{min} ) ; \\ {φ}_{1} = min ( max ( ( {d}_{{1}_{n}} - \frac{{c}_{{21}_{n}} {d}_{{2}_{n}}}{max ( {c}_{{22}_{n}} , {c}_{min} )} ) {D}_{φ}^{- 1} , {\underline{φ}}_{1} ) , {\overline{φ}}_{1} ) ; \\ {φ}_{2} = min ( max ( ( \frac{{c}_{{11}_{n}} {d}_{{2}_{n}}}{max ( {c}_{{22}_{n}} , {c}_{min} )} - \frac{{c}_{{21}_{n}} {d}_{{2}_{n}}}{max ( {c}_{{22}_{n}} , {c}_{min} )} ) {D}_{θ}^{- 1} , {\underline{φ}}_{2} ) , {\overline{φ}}_{2} ) ; . \\ n = 0 ; \\ {c}_{{11}_{n}} = 0 ; {c}_{{21}_{n}} = 0 ; {c}_{{22}_{n}} = 0 ; \\ {c}_{{1}_{n}} = 0 ; {c}_{{2}_{n}} = 0 ; \qquad ( 32 )$$

After φ₁ and φ₂ are calculated, the tire rotational spring rate Kᵥ is ready to be determined through the following algorithm:

$${λ}_{R} = \frac{φ}{2} ; \\ {λ}_{I} = \frac{\sqrt{- {φ}_{1}^{2} - 4 {φ}_{2}}}{2} ; \\ {λ}_{mag} = \sqrt{{λ}_{R}^{2} + {λ}_{I}^{2}} ; \\ Θ = a tan 2 ( {λ}_{I} , {I}_{R} ) ; \\ {K}_{v} = {M}_{i} \frac{( {log ( {λ}_{mag} )}^{2} + {Θ}^{2}}{4 {π}^{2} Δ T} - {K}_{s} ; \\ {K}_{v} = min ( max ( {K}_{v} , {\underline{K}}_{v} ) , {\overline{K}}_{v} ) ; \qquad ( 33 )$$

where Kᵥ and \overline{K}ᵥ are the lower and upper bounds of the vertical spring rate of a tire, respectively.

The screening conditions to activate the computation of the vertical tire spring rate include that the tire is not heavily braked, the wheel taking-off angle as in Equation (11) is small, the wheel longitudinal slip ratio as in Equation (12) is small, the suspension height is not constant, etc.

### Tire Imbalance Strength Identification

In step 130 the imbalance strength S may be determined in step 130. The case where there is an imbalanced mass in the wheel/tire assembly is shown in FIG. 6, where the imbalance mass ΔM is attached to the outer piece of the tire/wheel assembly and the distance between the imbalanced mass and the rotation center of the wheel tire assembly is κ. The actual location of the imbalanced mass may be different, as soon as the product ΔMκ is the same, the effect of the imbalanced force is the same. For this reason, a normalized variable S called the imbalance strength is

$$S = \frac{Δ M κ}{{M}_{i}} . \qquad ( 34 )$$

With increase of the tire rotational speed, the force applied to the inner piece in the vertical direction may be calculated as:

$$S {\{ \frac{{w}_{s}}{{r}_{0}} \}}^{2} sin ( {\int }_{0}^{t} \frac{{w}_{s}}{{r}_{0}} ⅆ t + {θ}_{0} ) \qquad ( 35 )$$

where θ₀ is the initial position angle of the imbalanced mass in the tire outer piece with respect to the horizontal plane, wₛ is the wheel speed sensor output and r₀ is the nominal rolling radius used to convert the wheel speed sensor output into an angular velocity of the tire.

Then the following variable χ is computed:

$$ϰ = [ {\ddot{z}}_{b} + \frac{{K}_{s}}{{M}_{i}} {z}_{b} + \frac{{D}_{s}}{{M}_{i}} {\dot{z}}_{b} ] - [ {\ddot{z}}_{sh} + \frac{{D}_{v} + {D}_{s}}{{M}_{i}} {\dot{z}}_{sh} + \frac{{K}_{v} + {K}_{s}}{{M}_{i}} {\ddot{z}}_{sh} ] \qquad ( 36 )$$

then based on the vertical dynamics of the tire/wheel inner piece, during the rotation of the imbalanced mass,

$$S sin ( {\int }_{0}^{t} \frac{{w}_{s}}{{r}_{0}} ⅆ t + {θ}_{0} ) = \frac{χ {r}_{0}^{2}}{{w}_{s}^{2}} . \qquad ( 37 )$$

By differentiating Equation (37),

$$S \frac{{w}_{s}}{{r}_{0}} cos ( {\int }_{0}^{t} \frac{{w}_{s}}{{r}_{0}} ⅆ t + {θ}_{0} ) = {r}_{0}^{2} \frac{ⅆ}{ⅆ t} \{ \frac{χ}{{w}_{s}^{2}} \} \qquad ( 38 )$$

then the imbalance strength can be calculated as:

$$S = \frac{{r}_{0}^{2}}{{w}_{s}^{2}} \sqrt{{χ}^{2} + {( {w}_{s} {r}_{0} \frac{ⅆ}{ⅆ t} [ \frac{χ}{{w}_{s}^{2}} ] \}}^{2}} . \qquad ( 39 )$$

An implemented algorithm reflecting the formula in Equation (39) may be expressed in the following through an averaging process:

$$γ = \frac{χ}{{w}_{s}^{2}} ; \\ {γ}_{d} ; \\ {A}_{n} = {A}_{n} + \frac{{r}_{0}^{2}}{{Nw}_{s}^{2}} \sqrt{{χ}^{2} + {\{ {w}_{s} {r}_{0} {γ}_{d} \}}^{2}} ; \\ n = n + 1 ; \qquad ( 40 )$$

When the averaging process achieves the predefined number N of the sample points, the imbalance strength can be obtained

if (n = N)
{

| | |
|---|---|
| S = Aₙ; | (41) |
| n = 0; | |
| Aₙ = 0; | |

}

If the tire derivative of the wheel speed sensor signal during certain conditions is almost zero, then Equation (39) can be further simplified as:

$$S = \frac{{r}_{0}^{2}}{{w}_{s}^{2}} \sqrt{{χ}^{2} + {\{ \frac{{r}_{0}}{{w}_{s}} \frac{ⅆ χ}{ⅆ t} \}}^{2}} . \qquad ( 42 )$$

The screening conditions for activating the computation of the imbalance strength may include that the vehicle speed is greater than a threshold, the lift angle of the wheel is small (guarantee that the tire contacts with the road), the wheel is not applied to large driving or braking torques, the vehicle is in steady state driving (no aggressive accelerations in both longitudinal and lateral directions).

### Tire Abnormal State Detection Methods

In step 132, the tire abnormal state detection utilizes the variables already calculated to decide whether the tires have an abnormality. There are two sets of tire abnormal states. One is inherent to the tire which are directly related to the structure of the tire, which may be referred to as the inherent abnormal states. The other is due to the operation condition changes in the other parts of the vehicle, which may be called parasite abnormal states.

The inherent abnormal states might include, but are not limited to tire pressure drop, tire imbalance, tire wear, and tire tread separation.

The parasitic abnormal states might include, but are not limited to tire rolling radius variation due to vehicle loading variation, tire rolling radius variation due to vehicle loading distribution variation, tire rolling radius variation due to the installation of mini tire or other off-spec tires, and high tire temperature during brake due to a sticking brake pad or other non-rubber related problems.

Therefore, it is desirable to separate the inherent tire abnormal states and the parasite tire abnormal states.

### Mini Tire Detection

In FIG. 12, the presence of a mini tire may be determined if the tire rolling radius deviates from a nominal tire rolling radius by a fixed amount in step 150. A mini spare is a spare tire that is used on a temporary basis and is typically smaller (lower radius) than a conventional tire. In step 152 the rotational spring rate and vertical spring rate of the tire are monitored to determine if they all converged to fixed values. Those fixed values can be obtained through empirical testing data for mini tires equipped with the vehicle. If steps 150 and 152 are true, step 154 determines a mini-spare is present. In steps 150 and 152, if the conditions are not met, step 156 is executed which returns the system to step 120 of FIG. 11.

### Tire Pressure Drop Detection

Referring to FIG. 13, a tire drop may be detected if the roll radius decreases in step 160. In step 162, if the rotational spring rate decreases and the vertical tire spring rate decreases, then a pressure drop is determined in step 164. In steps 160 and 162, if the conditions are not true, step 166 is executed in which step 120 of FIG. 11 is executed.

### Tire Imbalance Detection

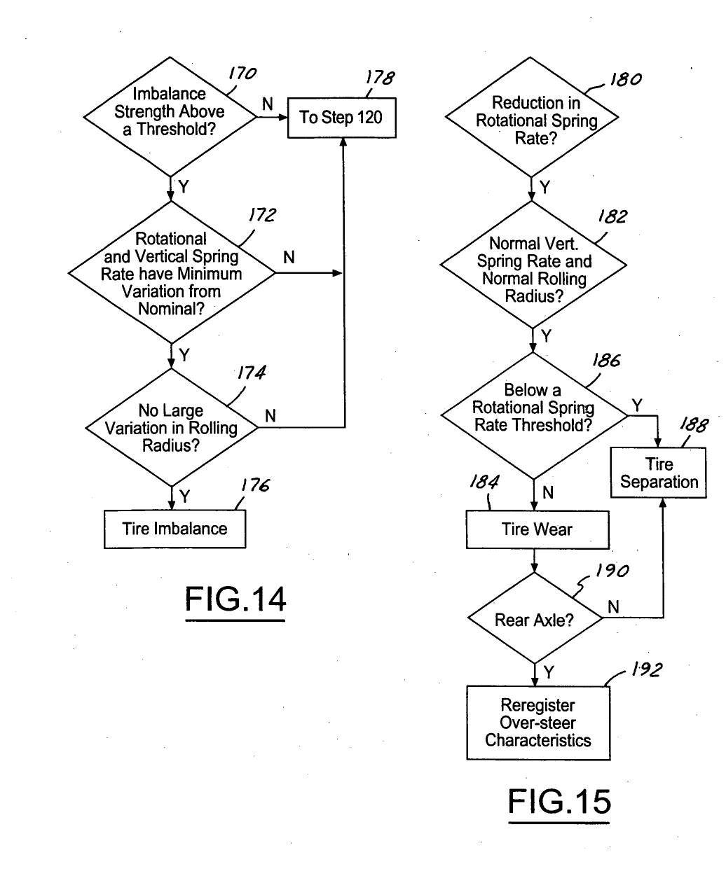

Referring now to FIG. 14, if the tire imbalance strength is above a threshold in step 170, and the tire rotational and vertical spring rates have minimum variation in comparison with their nominal values in step 172, step 174 is executed. In step 174, if the tire rolling radius does not have large variation an imbalance is detected in step 176. In steps 170-174, if the conditions are not true, step 178 is executed in which step 120 of FIG. 11 is executed.

### Tire Wear Detection and Tire Tread Separation

Referring now to FIG. 15, if a tire has significant reduction in its rotational spring rate in step 180, and vertical spring rate is normal, and the rolling radius is normal in step 182, then the tire may have significant wear in step 184. A significant wear of the tire implies the reduction in the tire's grip force, and the reduction in the torque applied from the road to the outer piece in the two-piece tire/wheel model.

Referring back to step 182, if the tire rotational spring rate reduces to below a lower bound and the rolling radius and the vertical spring rate are about-normal in step 186, tire tread separation may be detected in step 188.

Referring back to step 184, if tread wear is found and a vehicle is detected to have wear in rear axle or tread separation in rear axle in step 190, the vehicle over-steer characteristics will be re-registered in the vehicle stability control system and certain over-steer control thresholds will be adjusted so that the over-steer control is more sensitive in step 192. That is, earlier activations are possible to reduce potential chance for the vehicle to spin out.

### Vehicle Loading

Referring now to FIG. 16, if a tire has significant reduction in rolling radius in step 200, but the rotational and vertical spring rates of the same tire are normal in step 202, then there may be an unbalanced loading applied to that tire in step 204. In steps 200 and 202, if the conditions are not found, step 206 returns the system to step 120 of FIG. 11.

### Loading Distribution Detection

In step 204, if the two rear tires (rear axle) both have significant reduction in rolling radius in step 206, but the rotational and vertical spring rates are normal, then most likely there is a significant trunk loading in the vehicle as indicated in step 210.

If a vehicle is detected to have heavy loading in the rear axle, the vehicle over-steer characteristics will be re-registered in the vehicle stability control system and certain over-steer control threshold will be adjusted in step 212.

If all four tires have significant reduction in rolling radius, but the rotational and vertical spring rates are all normal, then there is likely a significant but balanced loading in the vehicle in step 216.

### Adjusting Vehicle Stability Controls in Response to the Tire Abnormal States

Referring back to FIG. 11, in step 132 (FIGS. 12-16), the tire abnormal states such as tire pressure drop, the presence of a mini tire, tire imbalance, tire wear/tread separation, vehicle loading distribution may be identified (or monitored constantly) by utilizing all the sensor signals used in a vehicle dynamic system. Those abnormal states can then be used to adjust the thresholds, or the activation criteria so as to achieve better performance for active safety systems such as roll stability control systems and yaw stability control systems in step 220. Also, the warning system may be activated in step 222 to alert the driver audibly or visually of an impending abnormal state.

Thus as can be seen, specific tire abnormal states such as but not limited to mini-spare detection, tire imbalance, and tire variation due to uneven vehicle loading may be determined using the tire parameters. Thus, multiple causes of a symptom may be isolated to one cause.

While particular embodiments of the invention have been shown and described, numerous variations and alternate embodiments will occur to those skilled in the art. Accordingly, it is intended that the invention be limited only in terms of the appended claims.

What is claimed is:

1. A method of controlling a vehicle comprising:
generating a wheel speed signal;
determining at least one of a vehicle longitudinal velocity, a vehicle lateral velocity, and a vehicle vertical velocity;
determining at least one of a yaw signal, a roll signal, and a pitch signal;
determining a tire abnormal state in response to the wheel speed, at least one of the vehicle longitudinal velocity, vehicle lateral velocity, and vehicle vertical velocity, and at least one of the yaw signal, the roll signal, and the pitch signal; and
controlling the vehicle in response to the tire abnormal state.

2. A method as recited in claim 1 wherein controlling the vehicle comprises generating a driver warning.

3. A method as recited in claim 1 wherein controlling the vehicle comprises controlling a dynamic control system.

4. A method as recited in claim 3 wherein the dynamic control system comprises an antilock brake system, a traction control system, a yaw stability control system or a rollover control system.

5. A method as recited in claim 1 wherein determining at least one of a vehicle longitudinal velocity, a vehicle lateral velocity, and a vehicle vertical velocity comprises determining a moving road frame longitudinal velocity.

6. A method as recited in claim 5 wherein determining a moving road frame longitudinal velocity comprises determining the moving road frame longitudinal velocity from the yaw signal, roll signal and the pitch signal.

7. A method as recited in claim 5 wherein determining a moving road frame longitudinal velocity comprises determining the moving road frame longitudinal velocity from the yaw signal, roll signal and the pitch signal, a relative roll angle and a relative pitch angle.

8. A method as recited-in claim 5 wherein determining a moving road frame longitudinal velocity comprises determining the moving road frame longitudinal velocity from the yaw signal, roll signal and the pitch signal and sensor misalignment signals.

9. A method as recited in claim 1 wherein determining at least one of a vehicle longitudinal velocity, a vehicle lateral velocity, and a vehicle vertical velocity comprises determining a moving road frame lateral velocity.

10. A method as recited in claim 9 wherein determining a moving road frame lateral velocity comprises determining the moving road frame lateral velocity from the yaw signal, roll signal and the pitch signal.

11. A method as recited in claim 9 wherein determining a moving road frame lateral velocity comprises determining the moving road frame lateral velocity from the yaw signal, roll signal and the pitch signal, a relative roll angle and a relative pitch angle.

12. A method as recited in claim 9 wherein determining a moving road frame lateral velocity comprises determining the moving road frame lateral velocity from the yaw signal, roll signal and the pitch signal and sensor misalignment signals.

13. A method as recited in claim 1 wherein determining at least one of a vehicle longitudinal velocity, a vehicle lateral velocity, and a vehicle vertical velocity comprises determining a moving road frame vertical velocity.

14. A method as recited in claim 13 wherein determining a moving road frame vertical velocity comprises determining the moving road frame vertical velocity from the yaw signal, roll signal and the pitch signal.

15. A method as recited in claim 13 wherein determining a moving road frame vertical velocity comprises determining the moving road frame vertical velocity from the yaw signal, roll signal and the pitch signal, a relative roll angle and a relative pitch angle.

16. A method as recited in claim 13 wherein determining a moving road frame vertical velocity comprises determining the moving road frame vertical velocity from the yaw signal, roll signal and the pitch signal and sensor misalignment signals.

17. A method as recited in claim 1 wherein determining a tire abnormal state comprises determining a tire parameter.

18. A method as recited in claim 17 wherein determining a tire parameter comprises determining a rolling radius, a vertical spring rate and a rotational spring rate.

19. A method as recited in claim 17 wherein determining a tire abnormal state comprises determining an inherent abnormal state.

20. A method as recited in claim 19 wherein determining an inherent abnormal state comprises determining a tire pressure drop.

21. A method as recited in claim 20 wherein determining a tire parameter comprises determining a rolling radius, a vertical spring rate and a rotational spring rate.

22. A method as recited in claim 19 wherein determining an inherent abnormal state comprises determining a tire imbalance.

23. A method as recited in claim 22 wherein determining a tire parameter comprises determining a rolling radius, a vertical spring rate, a rotational spring rate and an imbalance strength.

24. A method as recited in claim 19 wherein determining an inherent abnormal state comprises determining tire wear.

25. A method as recited in claim 24 wherein determining a tire parameter comprises determining a rolling radius, a vertical spring rate and a rotational spring rate.

26. A method as recited in claim 19 wherein determining an inherent abnormal state comprises determining tire tread separation.

27. A method as recited in claim 26 wherein determining a tire parameter comprises determining a rolling radius, a vertical spring rate and a rotational spring rate.

28. A method as recited in claim 1 wherein determining a tire abnormal state comprises determining a parasitic abnormal state.

29. A method as recited in claim 28 wherein determining a parasitic abnormal state comprises determining a tire rolling radius variation due to vehicle loading variation.

30. A method as recited in claim 28 wherein determining a parasitic abnormal state comprises determining a tire rolling radius variation due to the installation of a mini tire.

31. A method as recited in claim 28 wherein determining a parasitic abnormal state comprises determining a tire rolling radius variation due to the installation of an off specification tire.

32. A method as recited in claim 28 wherein determining a parasitic abnormal state comprises determining a high tire temperature during braking due to a sticking brake pad or a non-rubber related problems.

33. A method as recited in claim 1 wherein the yaw signal comprises a yaw rate signal.

34. A method as recited in claim 1 wherein the pitch signal comprises a pitch rate signal.

35. A method as recited in claim 1 wherein the roll signal comprises a roll rate signal.

36. A method as recited in claim 1 wherein determining at least one of a vehicle longitudinal velocity, a vehicle lateral velocity, and a vehicle vertical velocity comprises determining at least two of the longitudinal vehicle velocity, the lateral vehicle velocity, and the vehicle vertical velocity, and wherein determining a tire abnormal state comprises determining the tire abnormal state in response to at least two of the longitudinal vehicle velocity, the lateral vehicle velocity, and the vehicle vertical velocity.

37. A method as recited in claim 1 wherein determining at least one of a yaw signal, a roll signal, and a pitch signal comprises determining at least two of the yaw signal, the pitch signal, and the roll signal and wherein determining a tire abnormal state comprises determining the tire abnormal state in response to at least two of the yaw signal, the pitch signal, and the roll signal.

38. A method of controlling a vehicle comprising:
determining a vehicle longitudinal velocity;
determining a vehicle lateral velocity;
determining a vehicle vertical velocity;
determining a yaw signal;
determining a roll signal;
determining a pitch signal;
determining longitudinal wheel velocities, lateral wheel velocities and vertical wheel velocities from the vehicle longitudinal velocity, the vehicle lateral velocity, the vehicle vertical velocity, the yaw signal, the roll signal, and the pitch signal;
determining a tire parameter from the longitudinal wheel velocities, lateral wheel velocities and vertical wheel velocities;
determining a tire abnormal state in response to the tire parameter; and
controlling the vehicle in response to the tire abnormal state.
